(19) United States
(12) Patent Application Publication
(10) Pub. No.: US 2017/0055138 A1
(43) Pub. Date: Feb. 23, 2017

(54) COMPUTERIZED CRIME AND SUSPICIOUS ACTIVITY REPORTING SYSTEM

(71) Applicants: James F. McDonnell, Alexandria, VA (US); Bradley A. Clark, Round Hill, VA (US); Briana T. McClain, Alexandria, VA (US)

(72) Inventors: James F. McDonnell, Alexandria, VA (US); Bradley A. Clark, Round Hill, VA (US); Briana T. McClain, Alexandria, VA (US)

(21) Appl. No.: 14/829,017

(22) Filed: Aug. 18, 2015

(51) Int. Cl. H04W 4/22; G06Q 50/26; G06F 17/30; H04W 4/02

(52) U.S. Cl. CPC H04W 4/22; H04W 4/021; G06Q 50/265; G06F 17/30241

(57) ABSTRACT

A computerized crime and suspicious activity reporting system is disclosed. The system includes a computerized processor including programming configured to monitor inputs from a mobile computerized device in possession of the user. The inputs include an observed activity report input to the device by the user and location data for the mobile computerized device. The programming is further configured to reference database information to determine a local emergency dispatcher corresponding to the location data and report the observed activity report for display to the local emergency dispatcher based upon the referenced database information.

### FIELD OF THE DISCLOSURE

The present disclosure relates generally to a computerized system to manage information for law enforcement and public safety reporting. In particular, the disclosure provides a computerized system to enable a user to move between different emergency dispatch regions and seamlessly be able to report data in any of the regions.

### BACKGROUND

The statements in this section merely provide background information related to the present disclosure. Accordingly, such statements are not intended to constitute an admission of prior art.

Emergency dispatch centers are operated by local law enforcement or emergency management authorities. Different dispatch services within a single city may have similar or different reporting laws and protocols as compared with neighboring services. Dispatch services of entirely different cities within different states, for example, between Washington D.C., Philadelphia, and New York City, can have widely different laws and law enforcement protocols. A person traveling, for example, on a train between these three cities can have a wide range of difficulties attempting to connect with the right emergency dispatch center or suspicious activity reporting center and providing information in a way that any of the centers can accurately receive and act upon the information. Such reporting would be difficult enough with a voice message over a telephone call. Digital reporting, for example, enabling a push-button report of a crime or suspicious activity in progress would be even more difficult, with the computerized systems of each dispatch center being potentially different.

Cell phones or other mobile computerized devices are widely distributed, and many locations around the world include local cellular service, communications networks, or other similar systems over which a computerized device can send messages or data internationally.

Mobile computerized devices typically include locating systems or a locating device within the mobile device. In one exemplary embodiment, cellular devices in communication with cellular towers can quickly and accurately determine a current location for the phone based upon triangulated signals from the cellular towers. In another embodiment, global positioning satellites provide information to electronic devices, enabling the device to determine a location based upon the satellite signals. In another embodiment, proximity sensors and/or functionality provided by a Bluetooth® connection can be used to determine a location of a computerized device.

### SUMMARY

A computerized crime and suspicious activity reporting system is disclosed. The system includes a computerized processor including programming configured to monitor inputs from a mobile computerized device in possession of the user. The inputs include an observed activity report input to the device by the user and location data for the mobile computerized device. The programming is further configured to reference database information to determine a local emergency dispatcher corresponding to the location data and report the observed activity report for display to the local emergency dispatcher based upon the referenced database information.

### BRIEF DESCRIPTION OF THE DRAWINGS

One or more embodiments will now be described, by way of example, with reference to the accompanying drawings, in which:

FIG. 1 illustrates an exemplary sign that can be displayed in a public location enabling users to download the reporting program and to localize service through a cell phone to the correct local emergency dispatch center or suspicious activity reporting center, in accordance with the present disclosure;

FIG. 2 illustrates an exemplary cell phone displaying a one button reporting screen enabling a user to discreetly report a crime or suspicious activity in progress by pressing the button, in accordance with the present disclosure;

FIG. 3 illustrates an exemplary cell phone displaying a second, optional screen subsequent to an initial reporting screen, the second screen enabling the user to provide a specific category of crime or suspicious activity observed and to select between anonymous and user identified reporting, in accordance with the present disclosure;

FIG. 4 illustrates an exemplary cell phone displaying an additional optional screen subsequent to an initial reporting screen, the screen enabling a user to convey to the dispatch center whether the user is personally in a dangerous situation or the user is reporting from a safe location, in accordance with the present disclosure;

FIG. 5 illustrates an exemplary cell phone displaying an additional optional screen subsequent to an emergency screen, the screen enabling a user to provide additional information to the dispatch center, in accordance with the present disclosure;

FIG. 6 illustrates an exemplary cell phone displaying a reporting screen for a mass event such as a World Series game, where local authorities have indicated heightened sensitivity to certain classifications of reporting, in accordance with the present disclosure;

FIG. 7 illustrates an exemplary cell phone displaying information related to a change in dispatch center regions based upon a location of the phone, in accordance with the present disclosure;

FIG. 8 schematically illustrates an exemplary mobile computerized device such as a smart phone that can utilize the disclosed system, in accordance with the present disclosure;

FIG. 9 illustrates an exemplary dispatch control screen that can provided to authorities based upon reported criminal activities, in accordance with the present disclosure; and

FIG. 10 schematically illustrates an exemplary remote server that can be operated to process information to enable the disclosed system, in accordance with the present disclosure.

### DETAILED DESCRIPTION

Non-limiting and non-exhaustive embodiments of the present disclosure are described with reference to the following figures, wherein like reference numerals refer to like parts throughout the various views unless otherwise specified.

A computerized system is disclosed for enabling a user to report observed crime or suspicious activity across various reporting regions. Different emergency dispatch regions operate differently. Entirely different computerized systems can be used in different dispatch regions. Incorrectly providing form information to a dispatch system can slow or prevent important digital reporting from reaching the appropriate authority that should respond to the reporting. The disclosed system can include a method for providing a simplified input to a reporting user, referencing a present location for the phone, referencing database information related to the local emergency dispatcher for the location, referencing database information related to computerized protocols and reporting requirements for the local dispatcher to quickly and accurately receive the reporting, and translating and transmitting the user's reporting based upon the referenced details.

Persons observing a crime or suspicious activity may or may not be willing to make a voice phone call to an emergency dispatcher. If a criminal is nearby, a person may worry about his or her safety if seen with a phone up to his or her ear. A person leaving a voice call or message with an emergency dispatcher could worry about being implicated or labeled an informer based upon a recording of the reporting becoming public. Statistics show that when a user feels secure that reporting can be done safely and potentially anonymously, the user can be more likely to make the report to authorities. The disclosed system enables a person to make a report with a single or only a few taps to a screen, thereby reducing a chance of being identified by the criminal, and enables a person to report anonymously or semi-anonymously, where enabled by local laws and local dispatch policies.

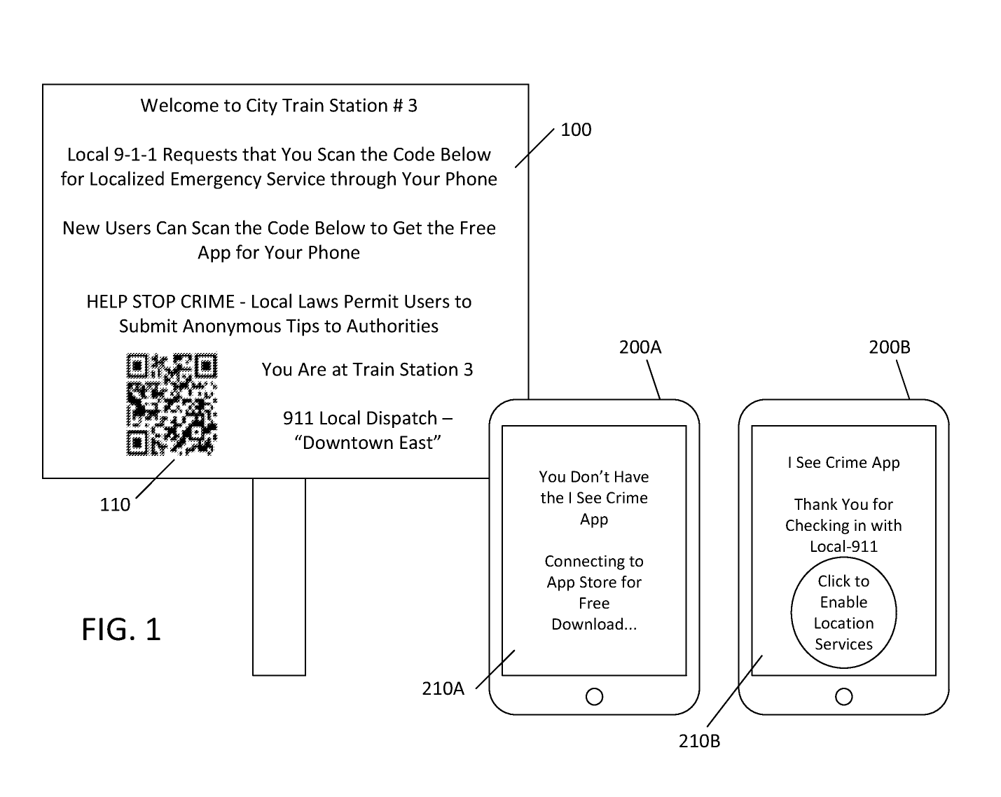

Referring now to the drawings, wherein the showings are for the purpose of illustrating certain exemplary embodiments only and not for the purpose of limiting the same, FIG. 1 illustrates an exemplary sign that can be displayed in a public location enabling users to download the reporting program and to localize service through a cell phone to the correct local emergency dispatch center. Portable computerized devices embodied as smart phones 200A and 200B are illustrated including view screens 210A and 210B, respectively. A sign 100 can be posted in a public space, the sign instructing users that wish to be enabled for the disclosed system to communicate with the local emergency dispatch center to scan an exemplary mark such as QR code 110. QR codes are known in the art as a universal mechanism for providing information quickly and easily to a cell phone or other similar computerized device. Other mechanisms such as UPC scan codes or alpha-numeric text including a website address can be used to aid in localizing the disclosed system, and the disclosure is not intended to be limited to the particular examples provided herein. Smart phone 200A, non initially including programming associated with the disclosed system, can be directed to a website or online location for downloading the appropriate programming. Smart phone 200B, including the disclosed programming, can activate the programming, log in or communicate with a correct local emergency dispatch service, and can monitor subsequent movement of the smart phone, for example, through subsequent QR code scans or by location services enabled on the phone, to determine when a change in the correct local emergency dispatch service has occurred.

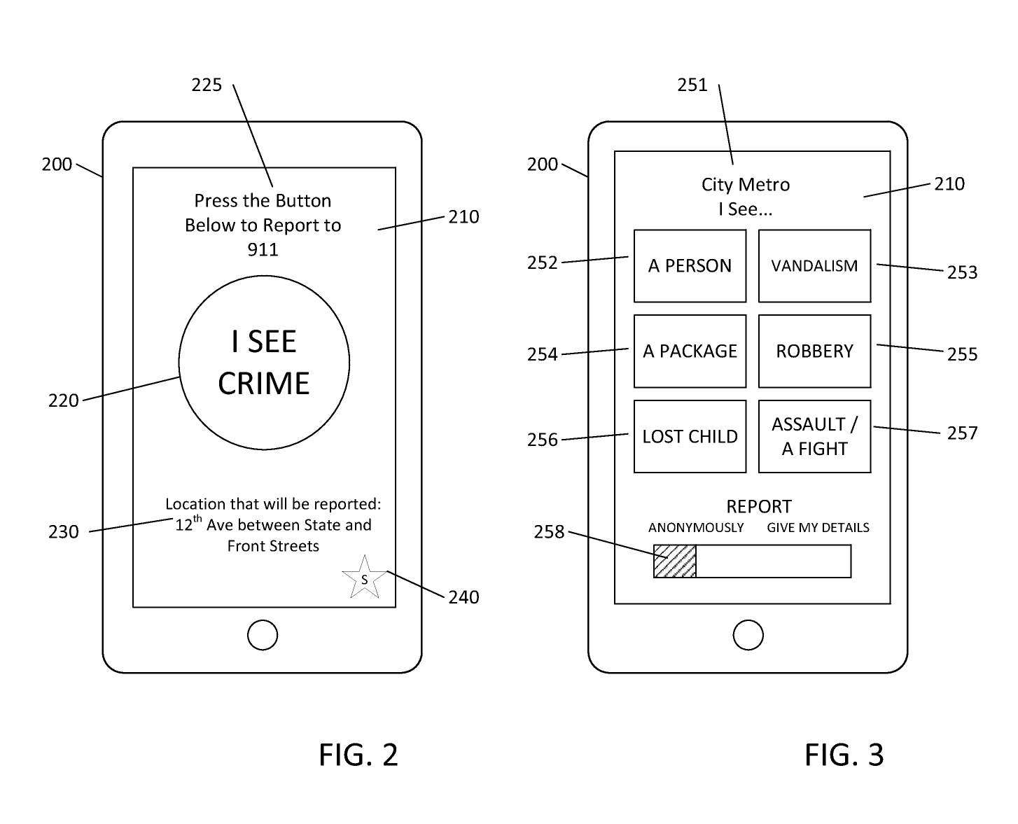

FIG. 2 illustrates an exemplary cell phone displaying a one button reporting screen enabling a user to discreetly report a crime or suspicious activity in progress by pressing the button. Smart phone 200 is illustrated including view screen 210. A single “I See Crime” reporting button is displayed upon the touch-input-enabled view screen 210. An optional banner 225 informs the user that his or her input will be transferred to an emergency dispatch service. A second optional banner provides a textual description of the present location of the smart phone, for example, as determined by a remote server with 3D digital map functions. A settings button 240 is provided enabling the user to set options or parameters for the disclosed system.

FIG. 3 illustrates an exemplary cell phone displaying a second, optional screen subsequent to an initial reporting screen, the second screen enabling the user to provide a specific category of crime or suspicious activity observed and to select between anonymous and user identified reporting. Smart phone 200 is illustrated including view screen 210. The illustrated screen can in one embodiment be provided to the user after the first, one-touch reporting screen. In one embodiment, the user, if he or she does nothing else, will provide a “criminal activity observed here” tip to the local dispatch center if none of the buttons on the view screen of FIG. 3 are activated. In another embodiment, the system requires the user to select from one of the preset categories of crime or suspicious activity before any message is sent to the local dispatch center. Banner 251 is provided. The categories represented by buttons 252 through 257 are exemplary. A number of alternative or additional categories or free-form reporting can be enabled, and the disclosure is not intended to be limited to the particular examples provided herein. Button 252 enables the user to report a suspicious person. Button 253 enables the user to report vandalism. Button 254 enables the user to report a suspicious package. Button 255 enables the user to report a robbery. Button 256 enables the user to report a lost child. Button 257 enables the user to report an assault or a fight. Specialized buttons can be enable by the local dispatcher for viewing upon the screen, for example, providing a special Amber Alert button upon the screen when such an alert has be locally initiated, permitting a user to acquire or provide information related to that alert but not listing such an option when no local Amber Alert has be initiated. Slider 258 enables the user to select between anonymously reporting the information or providing information such as name and phone number to the dispatcher.

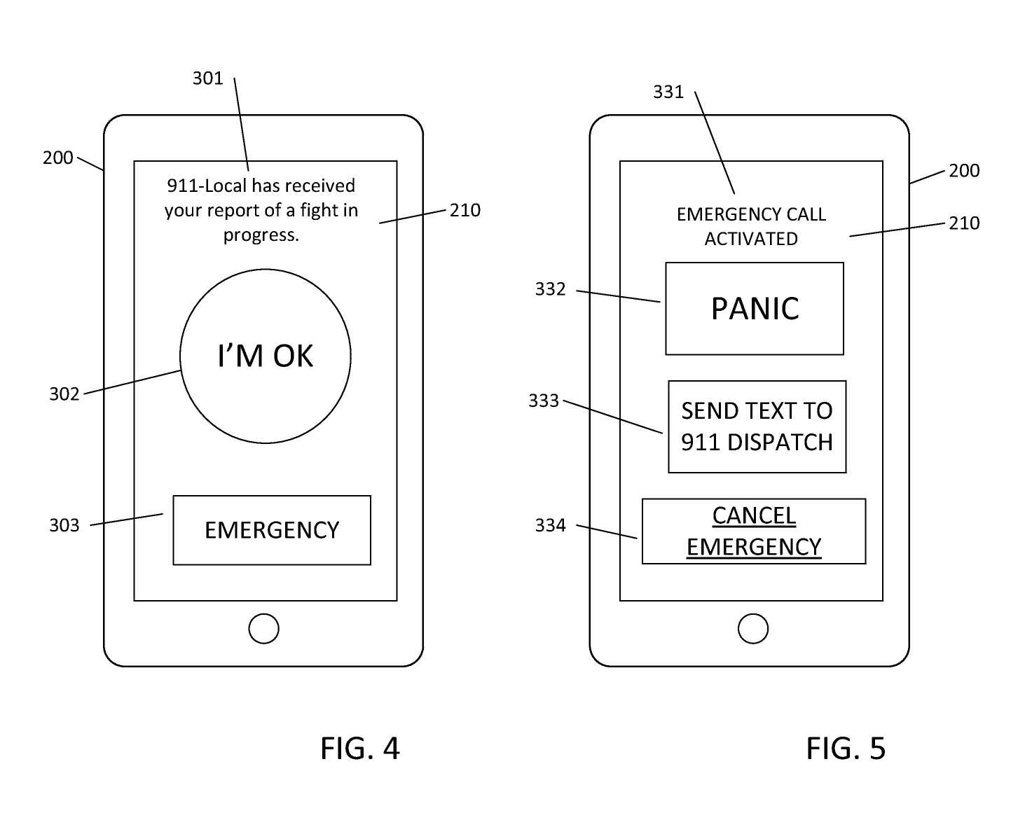

Conditions under which criminal acts are observed can be fluid. If a user of the system observes bad actors spraying graffiti, the user can take out his or her phone and click to report the bad actors. At that time, the user may feel safe in making the report. However, many things can happen in the presence of bad actors, and the user may later be made to feel unsafe and in physical jeopardy. FIG. 4 illustrates an exemplary cell phone displaying an additional optional screen subsequent to an initial reporting screen, the screen enabling a user to convey to the dispatch center whether the user is personally in a dangerous situation or the user is reporting from a safe location. Smart phone 200 is illustrated including view screen 210. A banner 301 is illustrated confirming for the user that the local dispatch center has confirmed receiving the report by the user. Buttons 302 and 303 are provided, enabling the user to send a subsequent message or messages stating that the user believes he or she is safe, or, alternatively, that an emergency condition exists requiring police response, respectively. In one embodiment, the buttons can be displayed persistently, such that if the user initially feels safe but then later feels in jeopardy, the user can press button 303 to update the situation.

FIG. 5 illustrates an exemplary cell phone displaying an additional optional screen subsequent to an emergency screen, the screen enabling a user to provide additional information to the dispatch center. Smart phone 200 is illustrated including view screen 210. In the event that the emergency button 303 of FIG. 4 is activated, the screen of FIG. 5 can be displayed. Banner 331 confirms for the user that the emergency button has been activated and that the emergency signal is confirmed received by the dispatch center. Button 332 allows the user to signal that a panic situation is in progress and that help is needed as soon as possible. Button 333 allows the user to sent a text message such as “shots fired, people are hurt, send police and ambulance.” Button 334 allows the user to cancel the emergency. Activation of button 334 cancelling the emergency can be password protected, for example, to prevent a bad actor from taking the phone from the user and cancelling the police call.

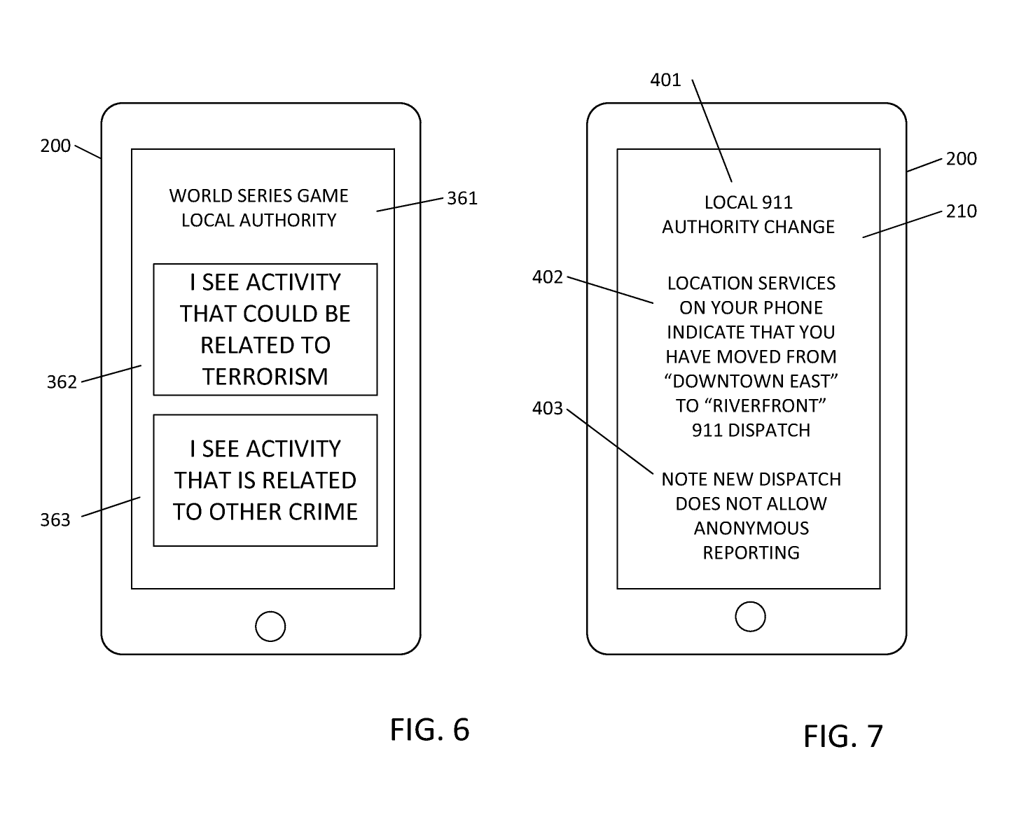

Law enforcement activities and the priorities of dispatch centers can be different depending upon what is going on in the community. On a quiet day, police may be able to respond to reports of minor violations such as loitering or ticket scalping. However, when a large sporting event or similar large gathering of people is going on in the community, the priorities of police can shift to avoiding mass violence or acts of terrorism. FIG. 6 illustrates an exemplary cell phone displaying a reporting screen for a mass event such as a World Series game, where local authorities have indicated heightened sensitivity to certain classifications of reporting. Smart phone 200 is illustrated including view screen 210. Banner 361 indicates to the user that a special situation is in effect, and the buttons that the user may be accustomed to seeing displayed by the system can be altered for the event. Button 362 prompts the user to report any suspicious activity that could be related to terrorism. Button 363 prompts the user to report any other kind of crime or suspicious activity.

The disclosed system can be used on various levels to filter and distribute information. For example, information that is thought to include terrorism or mass violence can instantly be routed to multiple dispatch centers or to higher authorities in law enforcement. Small offenses such as spitting on the sidewalk can either be accepted as reports but not forwarded to any dispatcher, or the system can politely encourage the user to only report crimes or suspicious activities of a threshold magnitude. The dispatch center, depending upon what is going on in the community or depending upon how many officers are available to respond, can be enabled to modulate either what kinds of reports are forwarded to the dispatch or what buttons are presented to users for selection. In some embodiments, instead of being directly connected to an emergency dispatcher, input from the disclosed cellular systems can be provided to a reporting “hotline.” Such a hotline can be monitored or reviewed by law enforcement or public safety officials. These officials can then make decisions about whether to provide the information to a dispatch center, record the information in a statistical database, to request more information from the user, etc.

Location services internal to the phone (GPS, wireless, cell phone tower triangulation, etc.) are known in the art. Such location services can be used to aid in determining a present correct emergency dispatch center for the phone's current location. Additionally or alternatively, QR codes or other similar location fixing displays can be presented to the user, for example, posted in train centers, digitally displayed on monitors in trains or taxicabs, or printed upon kiosks in airports. FIG. 7 illustrates an exemplary cell phone displaying information related to a change in dispatch center regions based upon a location of the phone. Smart phone 200 is illustrated including view screen 210. Banner 401 informs the user that a transition has been made from one dispatch center to another dispatch center. Banner 402 provides additional details about the change. Banner 403 can include procedural information, for example, informing the user of changes to local regulations or procedures regarding anonymous reporting.

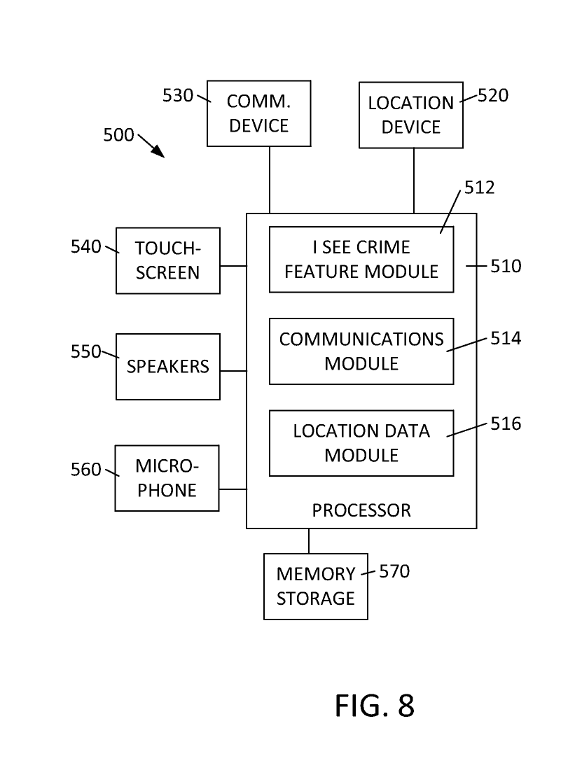

FIG. 8 schematically illustrates an exemplary mobile computerized device such as a smart phone that can utilize the disclosed system. Configuration 500 is exemplary of systems and devices within smart phone 200. Configuration 500 includes a processor 510 configured to operate programmed code, RAM memory, and durable memory storage 570 embodied as a hard drive, flash memory, or other similar devices. Processor 510 operates programming modules which are configured to operate programming accomplishing various aspects of the disclosed system. The programming modules provided herein may exist on a single device or may span multiple devices and are provided as a non-limiting example of how processes described herein can be operated.

Processor 510 includes a communication module 514 which utilizes a connected communications device 530 to communicate wirelessly with a remote server or other devices over a communications network such as a cellular network. Processor 510 further includes an I see crime feature module 512 configured to process commands from a remote server or monitor user inputs to the device and operate programming within processor 510 to implement steps or stages in a process based upon the disclosed system and related methods. Processor 510 further includes a location data module 516 including programming to provide location data of the user to a remote server at the permission of the user of the device.

Configuration 500 further includes a touch screen device 540, speakers 550, a microphone device 560, and a location device 520. Configuration 500 is exemplary, and the disclosure is not intended to be limited to the particular examples provided herein related to computerized devices.

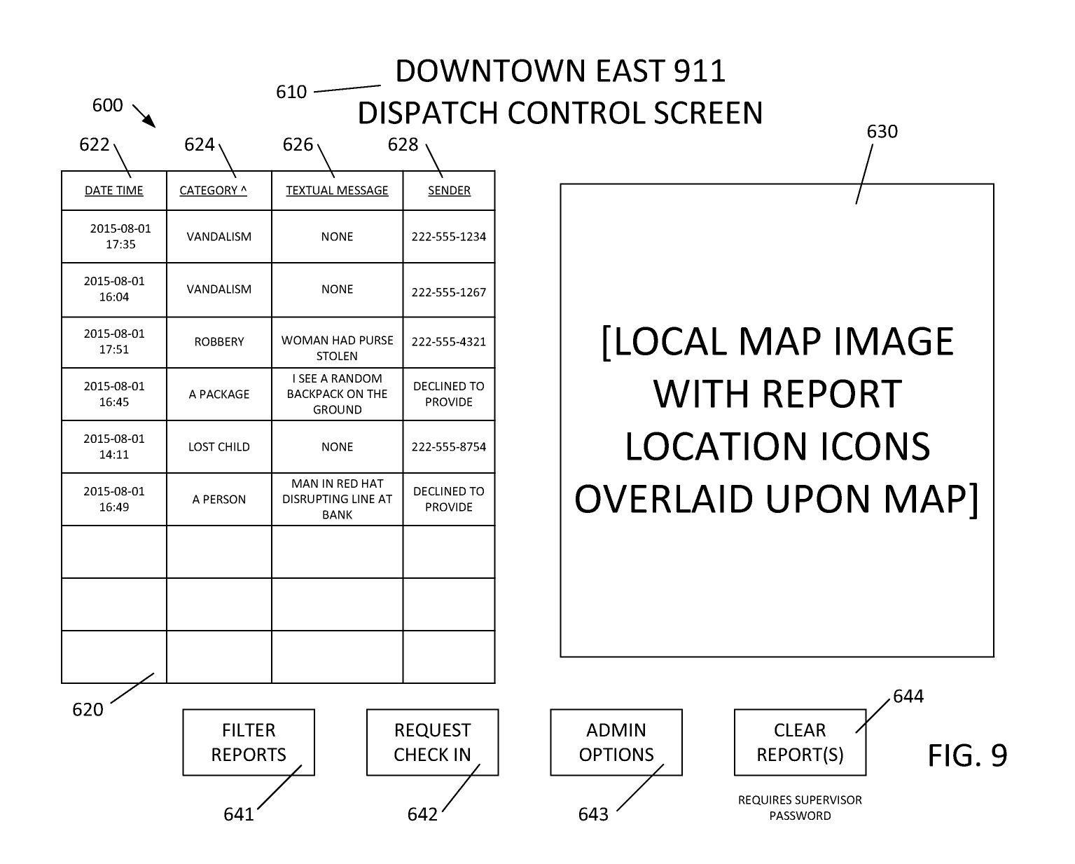

FIG. 9 illustrates an exemplary tactical display that can provided to authorities in the event that a need help feature is activated. Display 600 includes exemplary elements that can presented to a dispatcher at an emergency dispatch station. Banner 610 identifies the dispatch center for which information is being provided. Table 620 includes a plurality of sortable observed crime or suspicious activity reports that have been received by the system. Columns 622, 624, 626, and 628 include details relating to time and date stamps for the reports, categories of the reported crimes or suspicious activity, textual messages that the users can provide with the report, and information about the user that sent each report, if the user consented to such information being collected, respectively, for each of the observed crime or suspicious activity reports. Each of the labels at the top of columns 622, 624, 626, and 628 can be active buttons, each permitting the user to sort the table based upon the details of that column. The carrot indicator in label “CATEGORY ̂” can indicate that table 620 has been sorted according to the report categories. A map display 630 is provided for all or a portion of the region which the dispatcher is responsible for. Based upon location data provided with each report, icons or graphic indicators can be used to plot on the map display 630 where each report was made. Map display 630 can be interactive, for example, permitting the dispatcher to zoom in on a certain report and provide contextual landmarks upon the map. Button 641 enables the user to filter reports, for example, selecting which categories are to be displayed or selecting reports during a particular time period. Button 642, which may or may not be provided for a particular system depending upon privacy rules for the dispatcher, enables the dispatcher to request that a particular user that has submitted a report to provide a status report. Button 643 enables the user to set administrative options, for example, splitting or duplicating reports between a number of dispatch workers or forwarding reports to higher authorities. Button 644 enables a supervisor to clear one or more reports once appropriate action has been taken. The display of FIG. 9 is exemplary. A number of alternative display configurations and information for display are envisioned, and the disclosure is not intended to be limited to the exemplary display features presented in FIG. 9.

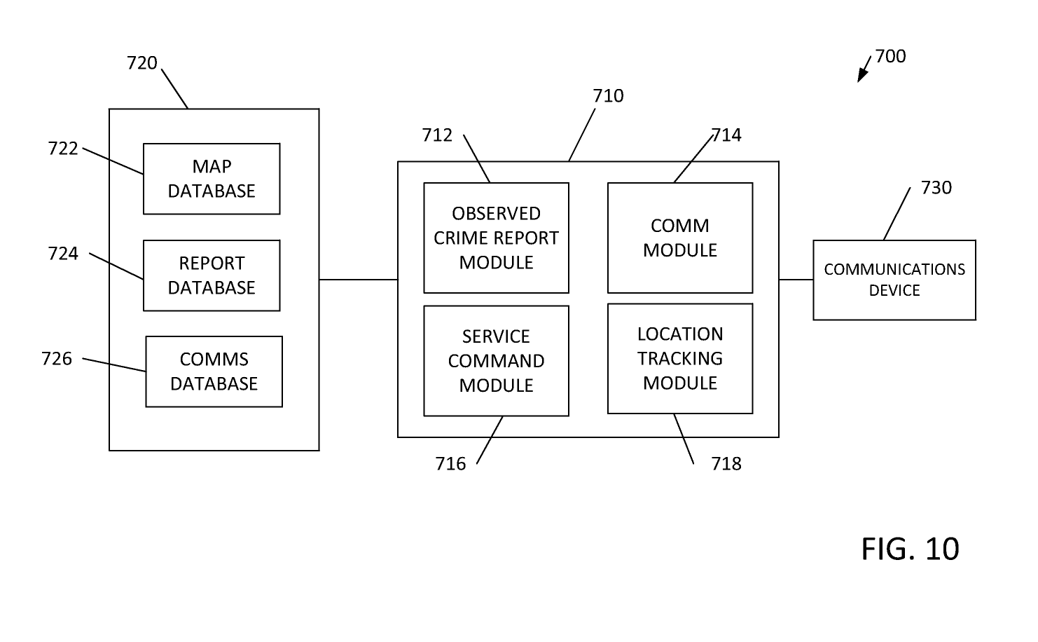

FIG. 10 schematically illustrates an exemplary remote server that can be operated to process information to enable the disclosed system. Configuration 700 is illustrated including memory storage 720, processing device 710, and communications device 730. Configuration 700 includes processing device 710 configured to operate programmed code, RAM memory, and access data from memory storage 812, the storage embodied as a hard drive, flash memory, or other similar devices. Processing device 710 operates programming modules which are configured to operate programming accomplishing various aspects of the disclosed system. The programming modules provided herein may exist on a single device or may span multiple devices and are provided as a non-limiting example of how processes described herein can be operated.

Processor 710 provides and receives information to/from communication device 730, communicating wirelessly with other remote servers, computerized devices, and other systems over a communications network such as a cellular network. Processor 710 includes observed crime report module 712, a communications module 714, a service command module 716, and a location tracking module 718. Observed crime or suspicious activity report module 712 includes programming to process data related to a plurality of crime or suspicious activity reports submitted by a plurality of users. Communications module 714 includes programming enabling the dispatcher to receive data from and contact users, local authorities, government agencies, emergency responders, and other personnel corresponding to reports in a particular locale. Service command module 716 includes programming configured to provide a display to a viewer at the emergency dispatch center, enable the viewer to share that display with other personnel, provide information and prompt requests to the users, and the other functionality enabled for the display viewer as disclosed herein. Location tracking module 718 includes programming to process information related to smart phone location data as provided by user's devices.

Memory storage 720 includes map database 722, report database 724, and communications database 726. Map database 722 includes information locations around the world so that location data can be combined with geographical information to provide a useful display to the viewer at the service provider. Report database 724 includes stored information about various devices enabled for use with the disclosed system. Communications database 726 includes stored information for use in communicating between various devices and remote systems as is required to operate the disclosed system.

Communications between the server and various devices of the disclosed system can be accomplished through a number of different communications connections or services known in the art. For example, a cellular connection can be utilized for two devices to communicate with each other. In other embodiments, telephone lines; broadband, digital subscriber line, or other internet connections; local area network or wireless local area networks; Bluetooth® connections; or other similar communications services can be utilized in accordance with the disclosed system.

The above description of illustrated examples of the present disclosure, including what is described in the Abstract, are not intended to be exhaustive or to be limited to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example values, times, etc., are provided for explanation purposes and that other values may also be employed in other embodiments and examples in accordance with the teachings of the present disclosure.

1. A computerized crime and suspicious activity reporting system enabling a user to report an observed activity across various reporting regions, comprising:
computerized processor including programming configured to:
monitor inputs from a mobile computerized device in possession of the user, the inputs including an observed activity report input to the device by the user and location data for the mobile computerized device;
reference database information to determine a local emergency dispatcher corresponding to the location data; and
report the observed activity report for display to the local emergency dispatcher based upon the referenced database information.

2. The computerized crime and suspicious activity reporting system of claim 1, wherein the location data comprises data retrieved from a location fixing display.

3. The computerized crime and suspicious activity reporting system of claim 2, wherein the location fixing display comprises a QR code.

4. The computerized crime and suspicious activity reporting system of claim 2, wherein the location fixing display provides an identity of the local emergency dispatcher.

5. The computerized crime and suspicious activity reporting system of claim 2, wherein the location data further comprises electronic location data provided by the mobile computerized device.

6. The computerized crime and suspicious activity reporting system of claim 1, wherein the location data comprises electronic location data provided by the mobile computerized device.

7. The computerized crime and suspicious activity reporting system of claim 1, wherein the programming is further configured to report the observed activity report anonymously.

8. The computerized crime and suspicious activity reporting system of claim 1, wherein the programming is further configured to provide an option to report the observed activity report anonymously and an option to provide personal information.

9. The computerized crime and suspicious activity reporting system of claim 1, wherein the programming is further configured to:
monitor updated location data for the mobile computerized device; and
determine a new local emergency dispatcher corresponding to the updated location data.

10. The computerized crime and suspicious activity reporting system of claim 1, wherein the programming is further configured to:
monitor a category for the observed activity report; and
report the observed activity report comprising the category to the local emergency dispatcher.

11. The computerized crime and suspicious activity reporting system of claim 1, wherein the programming is further configured to:
receive directed display options from the local emergency dispatcher; and
display the directed display options upon the device.

12. The computerized crime and suspicious activity reporting system of claim 1, wherein referencing database information to determine the local emergency dispatcher corresponding to the location data comprises referencing communication protocols for the local emergency dispatcher to facilitate reporting from the user to the local emergency dispatcher.

13. The computerized crime and suspicious activity reporting system of claim 1, wherein referencing database information to determine the local emergency dispatcher corresponding to the location data comprises referencing communication protocols for local emergency dispatchers to facilitate uninterrupted reporting from the user to the local emergency dispatchers as the user travels from a first reporting region to a second reporting region.

14. The computerized crime and suspicious activity reporting system of claim 13, further comprising displaying a common input screen to the user in the first reporting region and the second reporting region while reporting to each of the local emergency dispatchers according to different communication protocols for the local emergency dispatchers.

15. The computerized crime and suspicious activity reporting system of claim 13, further comprising displaying an updated reporting input screen to the user when moving from the first reporting region to the second reporting region.
